(19) United States
(12) Patent Application Publication
(10) Pub. No.: US 2012/0218154 A1
(43) Pub. Date: Aug. 30, 2012

(54) SLOT ANTENNA IN A SOLAR-REFLECTIVE GLAZING

(75) Inventors: Carson R. White, Westlake Village, CA (US); Hyok Jae Song, Agoura Hills, CA (US); Eray Yasan, Canton, MI (US)

(73) Assignee: General Motors LLC, Detroit, MI (US)

(21) Appl. No.: 13/034,807

(22) Filed: Feb. 25, 2011

(51) Int. Cl. H01Q 1/27; H01P 11/00; H01Q 13/10

(52) U.S. Cl. 343/713; 343/767; 29/600

(57) ABSTRACT

The described method and system provide an antenna feed for a slot antenna that may be patterned into a solar-reflective glazing layer with a virtual ground that is a short electrical distance from the antenna. One implementation of the present invention provides an antenna feed for a slot antenna patterned into the solar-reflective glazing used in a vehicle windshield. Because the antenna feed may incorporate a virtual ground that is a short electrical distance from the slot antenna, antenna performance may be improved over conventional on-glass vehicle antenna systems which use the vehicle chassis as a ground. Furthermore, patterning the slot antenna into the solar-reflective glazing layer and using a virtual ground in the antenna feed provides flexibility in antenna placement.

### BACKGROUND OF THE INVENTION

As the rules and regulations pertaining to automobile efficiency increase in severity, it is becoming increasingly important to consider sources of energy loss other than friction and other forces related to propulsion. For example, on a hot day, a vehicle's air-conditioning system may account for a noticeable fraction of the vehicle's energy use. To combat this loss of energy, certain steps are being taken to decrease the need for air-conditioning. One example of this is the use of solar control windows that reflect a substantial portion of incident solar radiation while maintaining substantial visible light transmittance.

While this applied layer may serve the noted function, i.e., reducing solar heating of the vehicle interior, the inventors have observed that it can also cause problems with vehicle radio and other RF performance. Specifically, solar reflective glazing blocks radio waves from entering the vehicle, and therefore conventional antennae cannot be placed on the glass or inside the vehicle, including cellular and GPS antennae. Conventional vehicle antennae are configured such that the vehicle chassis serves as the antenna ground. This configuration may seriously degrade the performance of on-glass antennas at microwave frequencies, including 1-10 GHz, due to electrical distance from the chassis to the antenna.

Thus, it is an object in part of this invention to take advantage of the solar-reflective glazing process by equipping vehicles with slot antennas, which can be patterned into a metallic solar-reflective glazing layer. Additionally, it is another object in part of the present invention to provide an antenna feed for a slot antenna capable of being adhered to solar-reflective glazing material with a virtual ground that is at a short electrical distance from the antenna.

However, while these objects underly certain implementations of the invention, it will be appreciated that the invention is not limited to systems that solve the problems noted herein. Moreover, the inventors have created the above body of information for the convenience of the reader and expressly disclaim all of the foregoing as prior art; the foregoing is a discussion of problems discovered and/or appreciated by the inventors, and is expressly not an attempt to review or catalog the prior art.

### BRIEF SUMMARY OF THE INVENTION

The invention provides an apparatus and method for providing an antenna feed to a slot antenna patterned or fabricated on a conductor layer sandwiched between dielectric layers, such as a solar-glazing conductor layer in a vehicle windshield, wherein the antenna feed may also provide a virtual ground without relying on either the vehicle chassis or an electrical connection to the conductor layer as the antenna ground.

In one implementation, the slot antenna is patterned into a conductive film that is sandwiched between two dielectric layers, and the antenna feed is attached to one of the dielectric layers using electrically insulating adhesive or some other suitable method such that it partially covers the slot. The antenna feed accepts a coaxial cable and electromagnetically couples it to the slot antenna. The feed may comprise a printed circuit board with a signal trace, a ground trace, and a means to connect the coaxial cable or other two-conductor transmission line. The printed circuit board may be either flexible or rigid, and the coaxial cable may be connected by means of a connector or directly soldered to it. The signal trace is electrically connected to the center conductor of the coaxial cable, and the ground trace is electrically connected to the ground/shield of the coaxial cable. The signal trace travels towards the slot antenna and crosses the slot at least once (either perpendicularly or obliquely), thereby coupling the coaxial center conductor to the slot antenna, and the signal trace is terminated in an open circuit.

In a further implementation, the ground trace may travel away from the slot and may take the form of a quarter-wave open circuited stub or a radial stub, thereby RF short-circuiting the coaxial shield to the ground plane and making the ground connection.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic structural diagram of one implementation of an antenna feed for a slot antenna presenting a see-through view from above;

FIG. 2 is a schematic structural diagram of the implementation shown in FIG. 1 from a cross-sectional side view;

FIG. 3 is a schematic structural diagram of one implementation of an antenna feed in the context of a vehicle windshield coated with solar-reflective glazing presenting a see-through view of the vehicle windshield;

FIG. 4 is a schematic structural diagram of the implementation shown in FIG. 3 from a cross-sectional view of the vehicle windshield.

FIG. 5 is a flowchart illustrating a process for fabricating an antenna feed in the context of a vehicle windshield coated with solar reflective glazing.

### DETAILED DESCRIPTION OF THE INVENTION

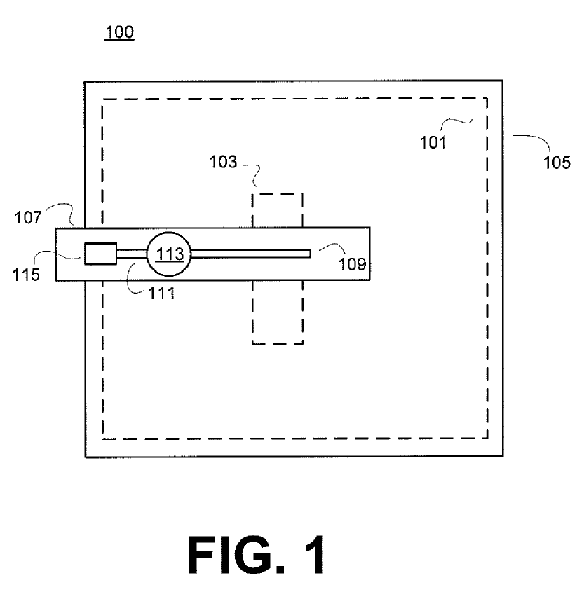

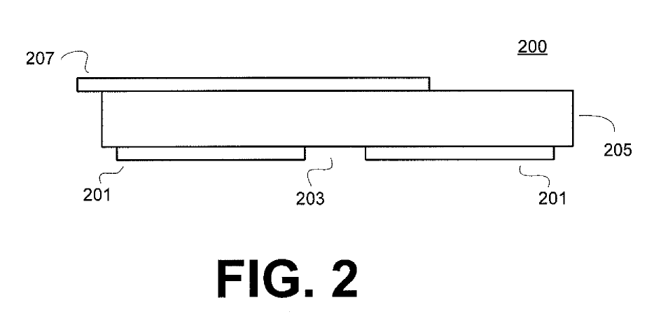

Turning to FIG. 1 and FIG. 2, the components of an antenna system 100 (200) for a slot antenna include a plate or sheet of conductive material 101 (201) with a slot formed 103 (203), at least one dielectric layer 105 (205), and an antenna feed 107 (207). A slot antenna is a type of antenna made out of a sheet or plate of electrically conductive material, i.e., a conductive metal or alloy. A slot missing from the sheet or plate is used to radiate electromagnetic waves when a driving frequency is applied, similar to certain other types of antenna (e.g. the dipole antenna). Advantages of the slot antenna include its adaptability, light weight, simple structure, ease of fabrication, and high power capability.

FIG. 1 depicts the system from above, while FIG. 2 depicts the system from a cross-sectional side perspective. It will be appreciated by one of ordinary skill in the art that the slot antenna may be a half-wave slot, full-wave slot, annular slot, or any other type of slot antenna, and that the positioning and physical properties of the various components can be varied depending on the desired antenna configuration.

In one implementation, the antenna feed 107 (207) is a printed circuit board with a signal trace 109, a ground trace 111, and a connection point accepting a coaxial cable or other two-conductor transmission line 113. The signal trace 109 travels towards the slot antenna and crosses the slot at least once either perpendicularly or obliquely. The signal trace 109 is terminated in an open circuit. The printed circuit board may be either flexible (e.g. Kapton film) or rigid (e.g. FR-4 fiberglass epoxy laminate). It will be appreciated by one of ordinary skill in the art that the printed circuit board is not limited to these two materials and may consist of other flexible or rigid materials.

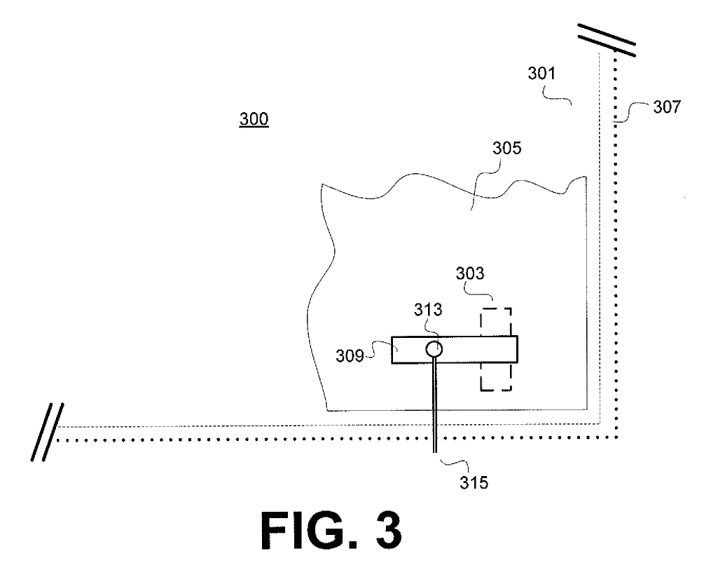

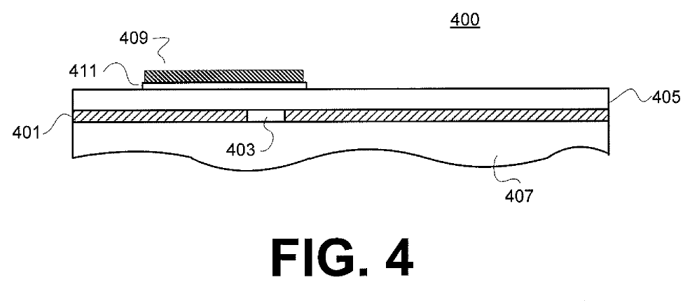

Turning now to FIG. 3 and FIG. 4, the antenna system 100 (200) of FIG. 1 and FIG. 2 is depicted in the context of the solar-reflective glazing of a vehicle windshield 300 (400). FIG. 3 depicts a straight-on view of the windshield, while FIG. 4 depicts a cross-sectional view of the windshield. For simplicity, only a section of the windshield 300 (400) and the solar-reflective glazing layer 301 (401) are depicted, and details from the antenna feed 309 (107) are omitted. The solar-reflective glazing layer 301 (401) is located between two dielectric layers 305 and 307, e.g., comprising tempered glass or the like in a typical windshield. The conductive material used for solar-reflective glazing is patterned or fabricated with a slot 303 (403) such that the solar-reflective glazing layer 301 (401) can be used as a slot antenna. The antenna feed 309 (409) may then be adhered to the windshield 300 (400) in an appropriate orientation with respect to the slot antenna using a non-conductive adhesive 411. A coaxial cable or other two-conductor transmission line 315 may be connected to the coaxial connection point 313 on the antenna feed 309 (409) to drive the antenna. It will be appreciated by one of ordinary skill in the art that the positioning of the slot antenna within the solar-reflective glazing layer may be arbitrarily varied and is not limited to the corner as shown. It will also be appreciated that different types of solar-reflective glazing material and dielectric material can be used.

Turning back to FIG. 1, with further reference to the context of FIG. 3 and FIG. 4, in a further implementation, the ground trace 111 travels away from the slot and may take the form of a quarter-wave open circuited stub or a radial stub 115. A quarter-wave open circuited stub or a radial stub may RF short-circuit the coaxial shield to the ground plane and act as a virtual ground for the slot antenna. This implementation allows the slot antenna system to be grounded a very short electrical distance from the slot antenna, enabling efficient excitation of microwave antennas. It also allows the placement of the antenna at arbitrary distances from the vehicle chassis, as the ground is no longer dependent upon the vehicle chassis.

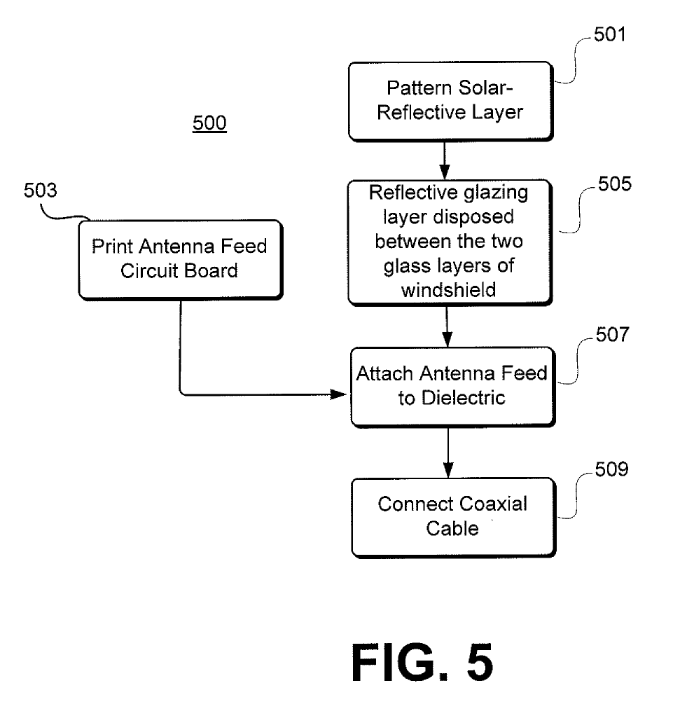

Turning to FIG. 5, the process 500 for providing an antenna feed to a slot antenna patterned or fabricated into a conductive solar-reflective glazing layer is shown via the illustrated flowchart. First, a conductive solar-reflective layer may be patterned or fabricated with a slot at stage 501, wherein the properties of the slot depend on the desired antenna configuration. A printed circuit board comprising a signal trace, a ground trace, and a connection point for a coaxial or other two-conductor cable may also be prepared for use as an antenna feed at stage 503. The signal trace may be printed such that it ends in an open circuit. The ground trace is printed such that it provides a virtual ground to the antenna system, and may take the form of a quarter-wave open circuited stub or a radial stub. The solar-reflective glazing layer is disposed between the two glass layers of the windshield at stage 505.

The antenna feed may then be attached to the windshield at stage 507 using non-conductive adhesive (or another suitable method) such that the signal trace of the antenna feed crosses the slot at least once, either perpendicularly or obliquely, and the ground trace of the antenna feed travels away from the slot. A coaxial cable or other two-conductor cable is then connected to the connection point on the antenna feed at stage 509. The coaxial or other two-conductor cable may be attached to the connection point by a standard connection unit or may be directly soldered together.

It will be appreciated by one of ordinary skill in the art that some processes depicted by FIG. 5 may be performed in a different order or in parallel. For example, a coaxial or other two-conductor cable may be attached to the antenna feed before the antenna feed is adhered to the dielectric.

It will be appreciated that the described system and method provide an antenna feed for a slot antenna that may be patterned into a solar-reflective glazing layer with a virtual ground that is a short electrical distance from the antenna. It will also be appreciated, however, that the foregoing methods and implementations are merely examples of the inventive principles, and that these illustrate only preferred techniques.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for providing an antenna feed to a slot antenna, the system comprising:
a layer of conductive solar-reflective material, formed with a slot such that the layer of conductive solar-reflective material is adapted to operate as a slot antenna;
a first dielectric layer attached to the layer of conductive solar-reflective material; and
an antenna feed attached to the first dielectric layer on the opposite side from the layer of conductive solar-reflective material, adapted to provide a driving frequency to the layer of solar-reflective material.

2. The system of claim 1, wherein the antenna feed is a printed circuit board, the printed circuit board further comprising:
a signal trace;
a ground trace; and
a connection point adapted to accept at least one of a coaxial cable and another two-conductor cable.

3. The system of claim 2, wherein the signal trace crosses the slot at least once and terminates in an open circuit.

4. The system of claim 3, wherein the at least one of a coaxial cable and another two-conductor cable is connected to the connection point by a connection unit.

5. The system of claim 3, wherein the at least one of a coaxial cable and another two-conductor cable is connected to the connection point by direct soldering.

6. The system of claim 4, wherein the ground trace provides a virtual ground for the slot antenna.

7. The system of claim 5, wherein the ground trace takes the form of a quarter-wave open circuited stub.

8. The system of claim 5, wherein the ground trace takes the form of a radial stub.

9. The system of claim 1, further comprising:
a second dielectric layer attached to the layer of conductive solar-reflective material on the opposite side relative to the first dielectric layer.

10. The system of claim 9, wherein the first and second dielectric layer is part of a vehicle windshield.

11. A method for providing an antenna feed to a slot antenna, the method comprising:
patterning a layer of conductive solar-reflective material with a slot;
applying a first layer of dielectric material to an area around the slot;
adhering an antenna feed to the first layer of dielectric material; and
connecting at least one of a coaxial cable and another two-conductor cable to the antenna feed.

12. The method of claim 11, wherein the antenna feed is a printed circuit board, the method further comprising:
printing a signal trace into the printed circuit board;
printing a ground trace into the printed circuit board; and
printing at least one of a coaxial cable connection point and another two-conductor cable connection point into the printed circuit board.

13. The method of claim 12, wherein the step of printing a signal trace into the printed circuit board further comprises printing the signal trace such that when the antenna feed is adhered to the first layer of dielectric material, the signal trace crosses the slot in the layer of conductive solar-reflective material at least once and the signal trace terminates in an open circuit.

14. The method of claim 13, wherein the step of connecting at least one of a coaxial cable and another two-conductor cable to the antenna feed includes directly soldering the coaxial cable or the other two-conductor cable to the antenna feed.

15. The method of claim 13, wherein the step of connecting at least one of a coaxial cable and another two-conductor cable to the antenna feed includes attaching the coaxial cable or the other two-conductor cable with a connection unit.

16. The method of claim 14, wherein the step of printing a ground trace into the printed circuit board further comprising printing the ground trace such that the ground trace provides a virtual ground for the slot antenna.

17. The method of claim 15, wherein the ground trace forms a quarter-wave open circuited stub.

18. The method of claim 15, wherein the ground trace forms a radial stub.

19. The method of claim 11, the method further comprising:
applying the layer of solar-reflective conductive material to a second dielectric layer.

20. The method of claim 19, wherein the first and second dielectric layer is a part of a vehicle windshield.
